(19) United States
(12) Patent Application Publication
(10) Pub. No.: US 2018/0012512 A1
(43) Pub. Date: Jan. 11, 2018

(54) Magic Squares - An Arithmetic Craft and Game

(71) Applicant: Simon Yi-Jiong Wu, Union City, CA (US)

(72) Inventor: Simon Yi-Jiong Wu, Union City, CA (US)

(21) Appl. No.: 14/997,998

(22) Filed: Jan. 18, 2016

(51) Int. Cl. G09B 23/02; G09B 19/02; G09B 1/00

(52) U.S. Cl. CPC G09B 23/02; G09B 1/00; G09B 19/02

(57) ABSTRACT

Two embodiments of the arithmetic craft of Magic Squares: 1) an assembly of unit square chips, hundredth square chips, lumped hundredth square chips, and a square baseboard with a size of 10×10 unit chips; 2) an assembly of (larger) unit square chips, hundredth square chips, lumped hundredth square chips, and a (smaller) square baseboard with a size of 5×5 unit chips. All the arithmetic games can be played accordingly. Other embodiments are described and shown.

### BACKGROUND—PRIOR ART

Math crafts have been invented since ancient times for various purposes and practices. A piece of rope with 12 knots of equal distance was used to form a right triangle for measuring and making sure that two construction components were perpendicular to each other. Abacus was invented for daily accounting in oriental countries until being replaced by calculator. Napier's bones are a multiplication tool taught by some of the middle-school textbooks today. Of course, calculator is the most powerful math tool for all purposes. However, the math crafts invented in history are studied as part of culture. And yet, gaming with math crafts can be creative and entertaining.

Magic Squares follow the idea of modeling arithmetic by geometry. Based on the concept of area, revealing never before relations between numbers and squares, calculating operations and manual manipulations, prime numbers and rectangle screens, the method is straightforward. Numbers are viewed from a new perspective. Instead of following rules step by step, a student is able to visualize what are product, quotient, square root, etc. And playing games artistically with patterns of squares will certainly make learning more interesting.

Old way of rote learning (simply memorizing multiplication table, for example) is not enough. In agreement with the Common Core standards, Magic Squares are a method for learning math in a sense of construction, symbolism, and creativity. Four operations (addition, subtraction, multiplication, and division) can be carried out on a baseboard by manipulating square chips—counting the number of chips, building the rectangles, reading the numbers from the sidelines, etc. Associative, commutative, and distributive properties can be tested easily by the same token. Additive identity (zero is nothing), multiplicative identity (unit-side square), and impossibility of dividing by zero, are intrinsic to the craft. The square of a number can be found by building a square, and the irrational numbers like √2 can be found by rebuilding a square on and on. And yet, some of the basic principles of prime numbers can be shown by simple geometry—building rectangles on the baseboard. A rectangle screen of prime numbers can be made for middle-school students to understand.

The arithmetic craft of Magic Squares is an assembly of: a square baseboard with a size of 10×10 unit squares; unit square chips; hundredth square chips; and lumped hundredth square chips, in one embodiment.

### SUMMARY

In accordance with one embodiment, a math craft comprises unit square chips, hundredth square chips, lumped hundredth square chips, and a square baseboard on which all the arithmetic games, including screening prime numbers, can be played.

### Advantages

Accordingly several advantages of one or more aspects are as follows: to provide a math craft that aids arithmetic teaching and learning by novel geometric modeling—all the four operations can be performed on numbers with decimal point; arithmetic properties including the ones intrinsic to the craft can be easily tested; squaring a number is same as building a square; the digits of an irrational number resulted from square root can be obtained in the steps of square rebuilding; prime numbers can be studied by geometry—showing some of the fundamental principles and making the rectangle screen of prime numbers; factoring a large number is made easy by steps of making up a rectangle; and after all, a relation between the numbers and square geometry in the arithmetic framework is unraveled by such a simple mechanical set-up. Other advantages of one or more aspects will be apparent from a consideration of the drawings and ensuing description.

### DRAWINGS—FIGURES

In the drawings, closely related figures have the same number but different alphabetic suffixes.

FIGS. 1A to 1B show assemblies of the arithmetic craft of Magic Squares (not to scale): a square baseboard with 10 unit square chips on each side and a second square baseboard with 5 unit square chips on each side, a unit square chip, a hundredth square chip, and lumped hundredth square chips, in accordance with two embodiments.

FIG. 2 shows addition and subtraction operations of 2+1=3 and 2−1=1.

FIG. 3 shows multiplication operation of 2.1×1.2=2.52.

FIG. 4 shows division operations of 1.2/2=0.6 and 14/3=4+2/3.

FIG. 5 shows square operations of 2.1²=4.41 and 1.2²=1.44.

FIG. 6 shows square root operation of √3=1.7 . . .

FIG. 7 shows success to build a rectangle by 10 and fail to build a rectangle by 29.

FIG. 8 shows prime 7-testers and 11-testers.

FIGS. 9A to 9B show 163 is screened out as a prime number by 11-testers and 7-testers.

FIGS. 10A to 10B show factoring 713 and 1.43.

FIG. 11 shows 12 is the LCM of the numbers 2, 3, 4, and 6.

FIG. 12 shows an assembly of cubes for the games in 3D.

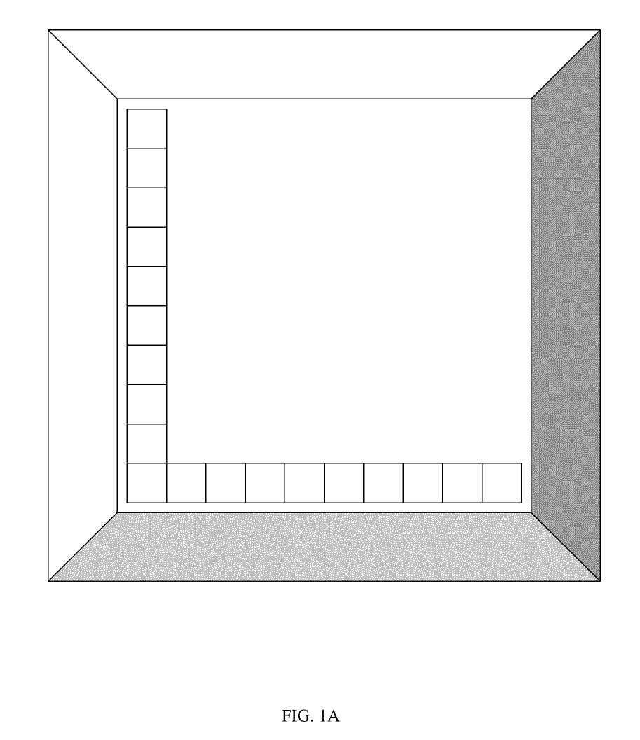

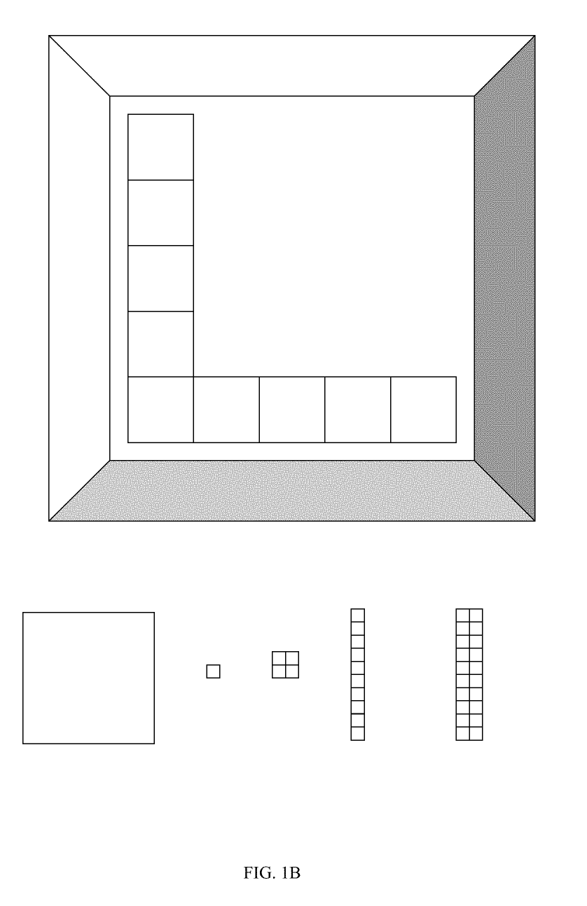

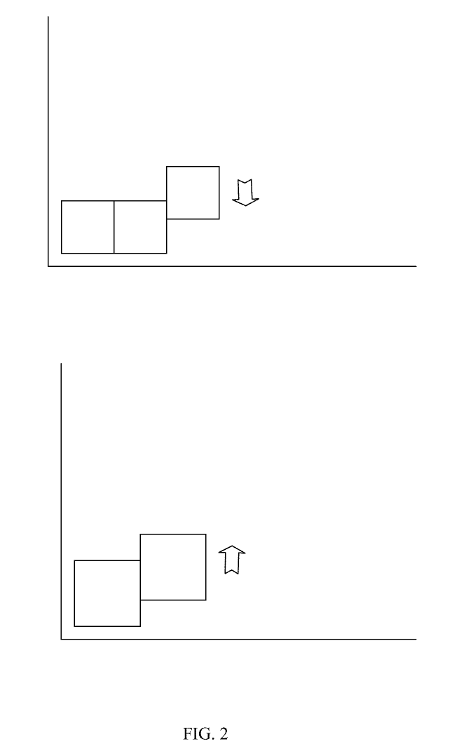

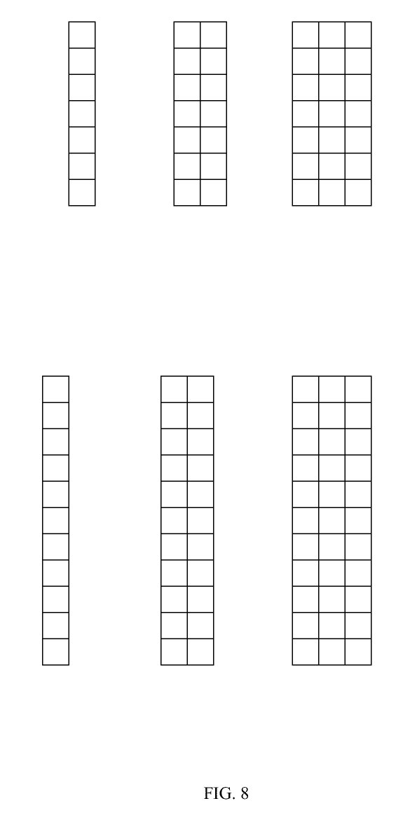

### DETAILED DESCRIPTIONS—FIGS. 1A TO 1B AND FIG. 8—TWO EMBODIMENTS

In the first embodiment, there are 100 unit square chips and 10000 hundredth square chips lumped in various ways for quick fit-in. The operations of addition, subtraction, multiplication, division, square, and square root can be carried out on numbers with decimal point in the range between 0 and 100 on a square baseboard. The limitation on digits comes solely from the difficulty in subdivision of hundredth square chip into ten-thousandth. On the other hand, large numbers like 1000, 10000, etc. can be represented by unit square chip as well.

In the second embodiment, there are 25 larger unit square chips with a smaller baseboard for playing easier games of all the operations. In this set-up, the hundredth square chips are larger for playing the games of screening prime numbers more easily. As a hundredth square chip can be chosen to represent the unit of natural numbers, the rectangle screen is capable of sieving out prime numbers in the range between 1 and 2500.

Fitting in lumped prime testers, the games can be played quickly. Lumped 7-testers, for example, are a column of 7 square chips, two columns of 14 square chips, etc. The prime testers like 7-testers, 11-testers, 13-testers, and so forth, form rectangle screens of prime numbers in the corresponding ranges of natural numbers.

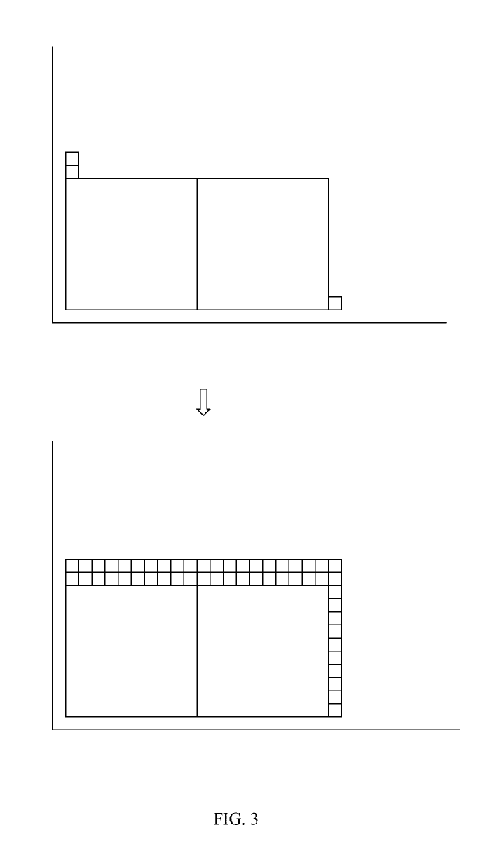

### Operations—FIGS. 3, 4, 5, 6, 7, 9A, 9B, 10A, 10B

Numbers with digits after decimal point between 0 and 100 are represented by unit chips and hundredth chips (in the first embodiment).

Multiplication (FIG. 3): lay down the multiplicand and multiplier from the corner along the horizontal (bottom) and vertical (left) lines respectively; fill the chips in the space to form a rectangle; the product is found by counting the chips of the rectangle.

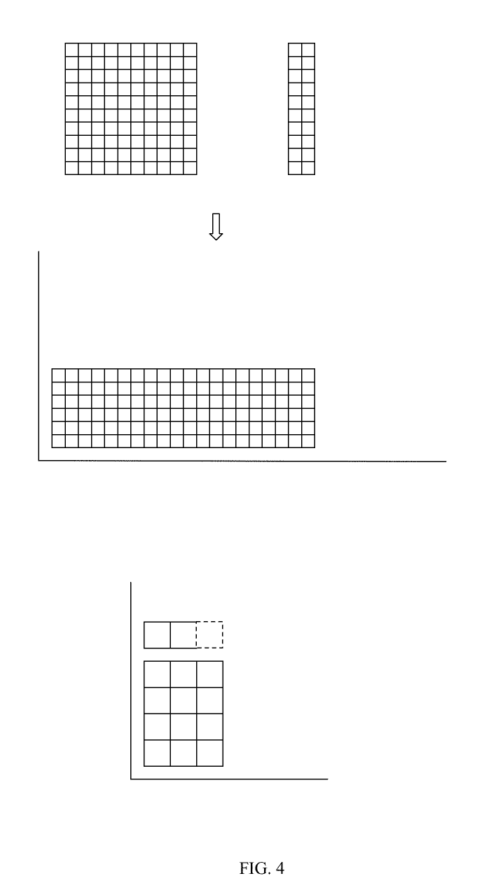

Division (FIG. 4): take the chips representing the dividend and split them; lay them down from the corner along the bottom line with the number of divisor to form a rectangle; the quotient is found by reading the chip marks of the rectangle on the vertical line. When one integer is not divided into another, the top row is in short of being part of the rectangle and the remainder is found by the number of the squares in the row over the divisor.

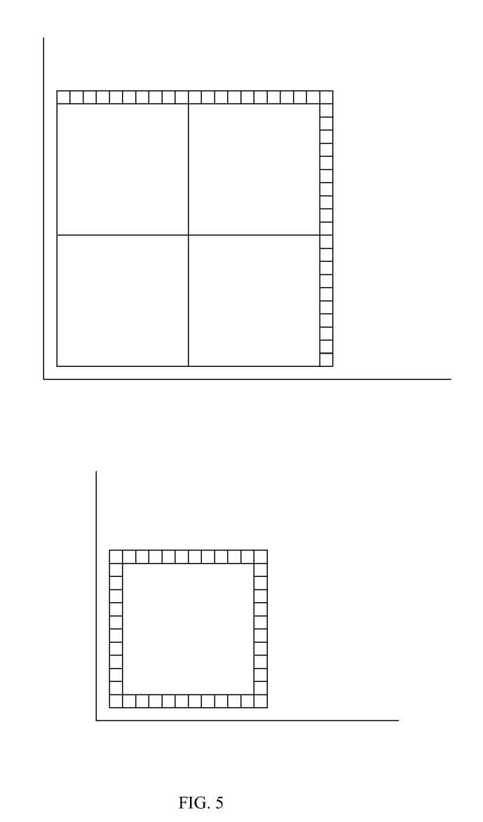

Square (FIG. 5): square is the same as multiplication—form a square and count the chips.

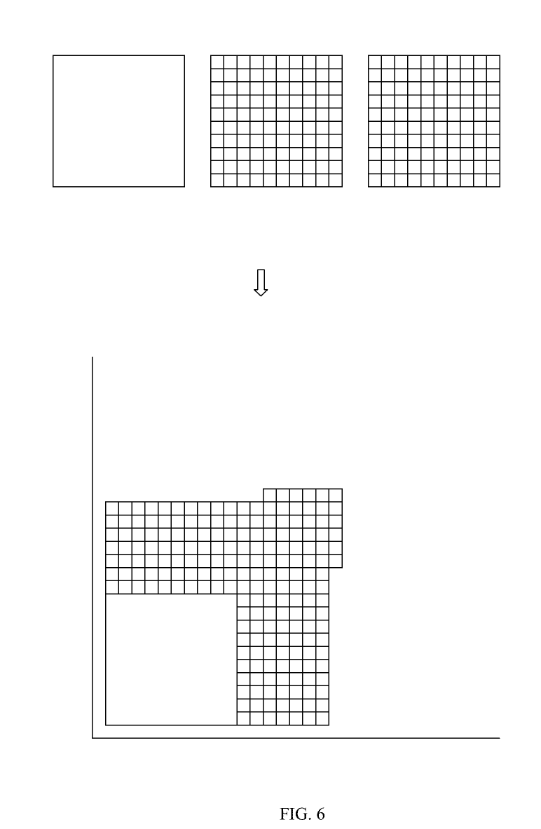

Square-root (FIG. 6): take the chips representing the number and split them; build a square as close as possible from the corner; the square root is found from reading the chip marks on either the bottom line or the vertical line.

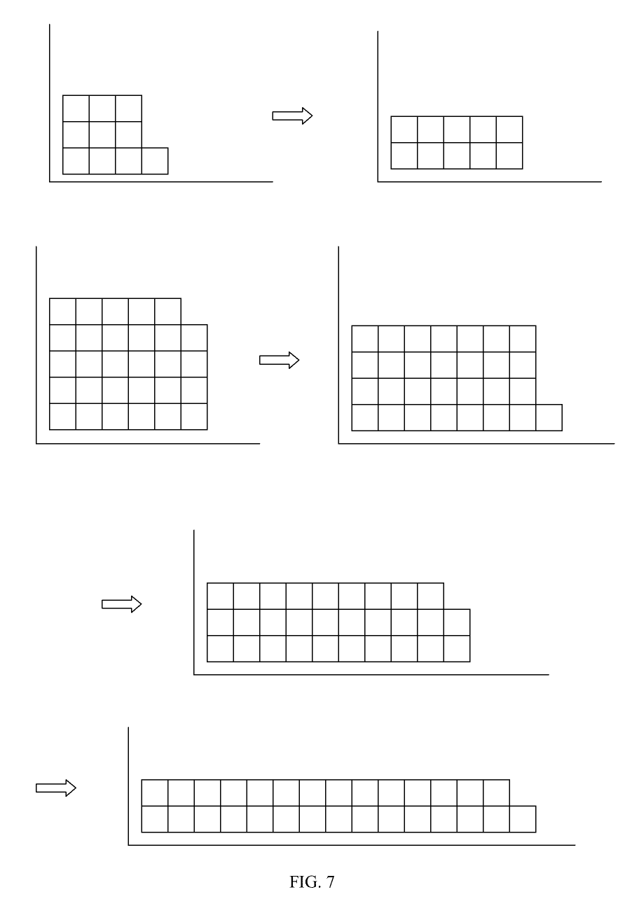

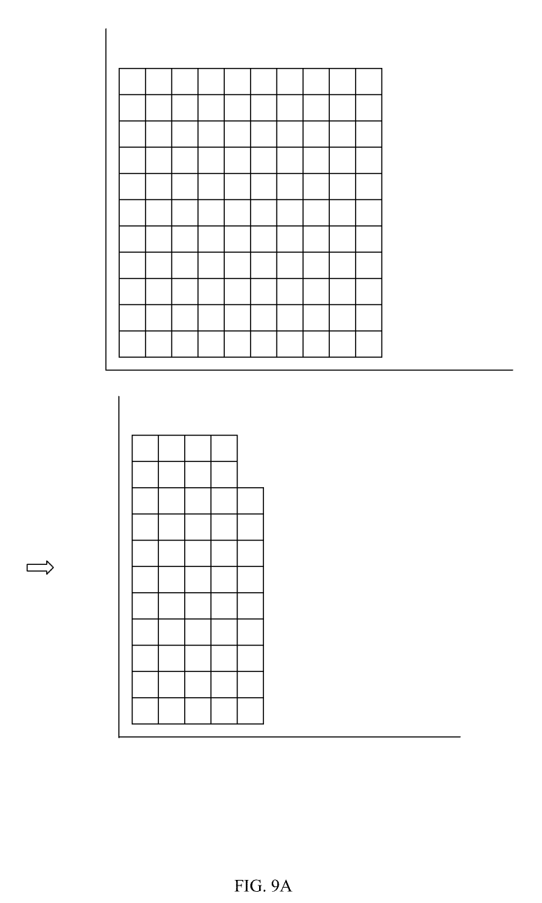

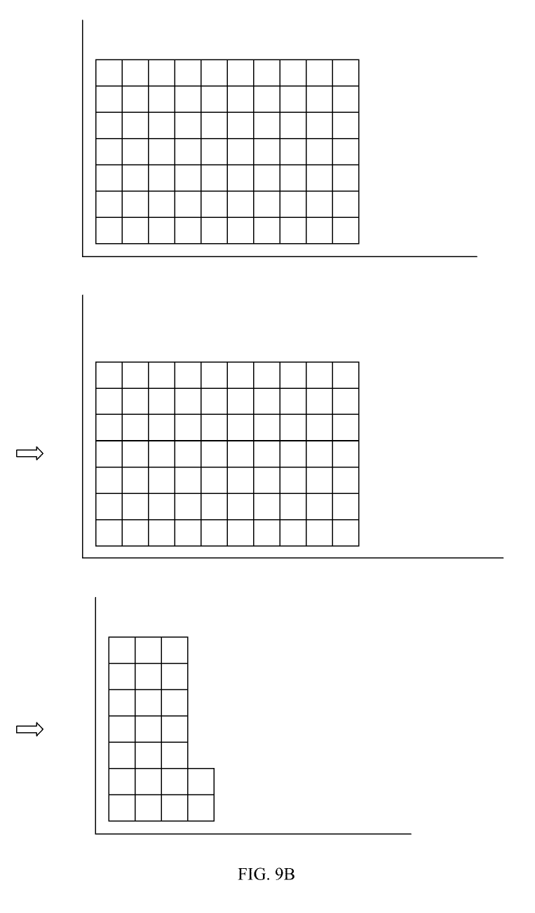

Rectangle screen of prime numbers (FIGS. 7 and 9A to 9B): the screening operation is based on that no rectangle can be built by a prime number. To play the game, a few rules have to be followed. Rule 1: by the definition of a prime number, unit-side rectangle is excluded. Rule 2: the width and length of a rectangle are symmetric. Rule 3: one side of a rectangle needs only to be a prime number when screening. Rule 3 can be explained by: a composite number like 45=3²·5 has different ways of building a rectangle, if 3 can be a side of a rectangle, then 9 doesn't have to be tested for being a side of a rectangle; on the other hand, 7 is not a prime factor of 45, so building a rectangle with a side 7 must be a failure.

Screening begins with building a square as close as possible by the number (remember any number falls in between two neighboring square numbers). If it is a square, then the number is composite; if it is not, then build a rectangle by the side of the square (skip if it is not prime); if it fails, then the next rectangle to be built must have a side of a prime number next to and smaller than the number of the side of the square; if a rectangle is successfully built by the number, then the number is composite. The process continues until all the smaller prime numbers are tested. All fails screen out the number as a prime number.

In FIG. 7, 10 is tested to be a composite number, and 29 is screened out as a prime number (testing by 4 is in fact unnecessary). To play the game in a more sophisticated way, the knowledge of divisibility by 3 and 5 is assumed: the sum of the digits of a number can be divided by 3; the last digit of a number is either 5 or 0. Yet, an even number is always composite. So any odd number between 1 and 49 needs to be tested just by its divisibility by 3 and 5.

In FIGS. 9A to 9B, 163 is chosen for screening. It is odd, and cannot be divided by 3 and 5. It falls in between 12² and 13². 12, a composite number, can be skipped. Screening by 11-testers and 7-testers show all fails in building rectangle. Therefore, 163 is a prime number. With hundredth square chips in the second embodiment, numbers up to 2500 can be screened by the method.

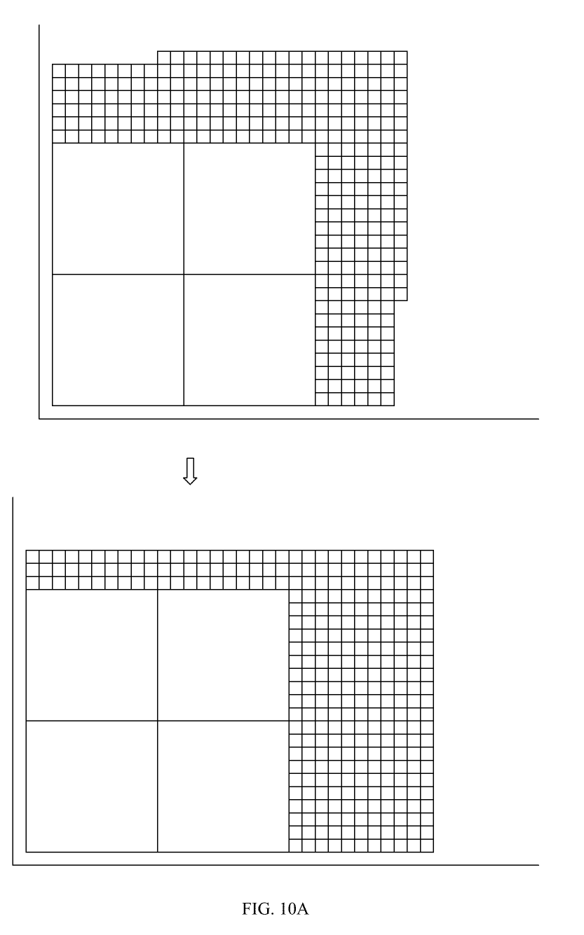

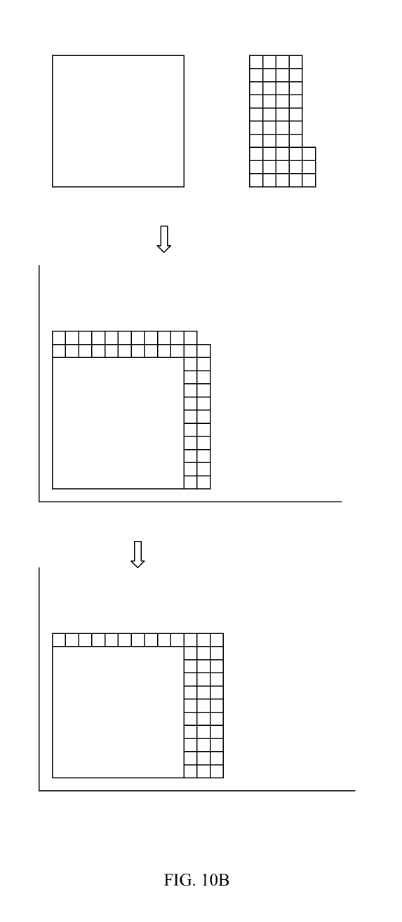

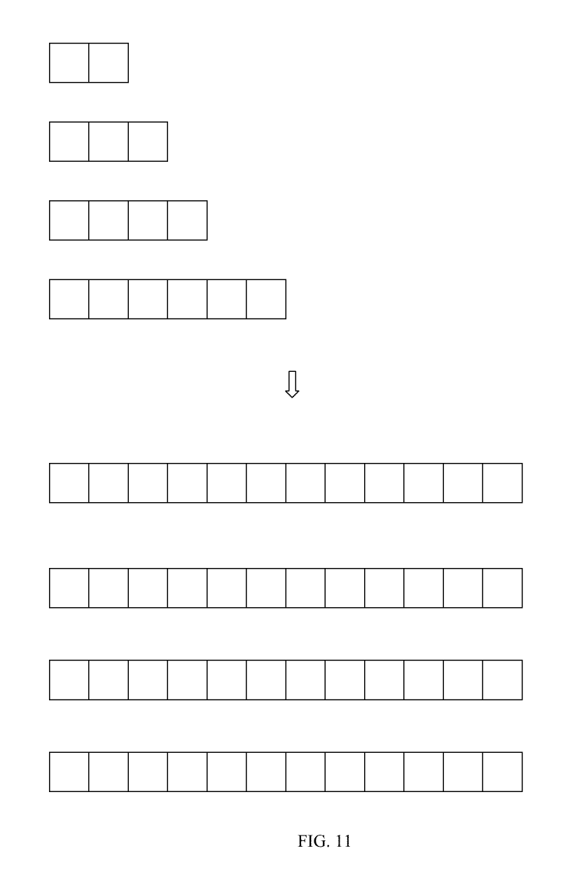

Based on the principles of rectangle screen, factoring a large number can be made easy and interesting. For factoring 713, a unit square chip in the second embodiment is chosen to represent 100. In FIG. 10A, a square of 26×26 is built as close as possible to the number (with 26²<713). The next step is a try on the next prime which is 23. Remove the rows of squares above 23 and lay them down column by column at the right side—a rectangle of 31×23 is successfully built. Therefore, 713=31×23. The well-known Mersenne number (M₁₁=2¹¹−1)) can be factored in the same fashion. Moreover, numbers with decimal point can be factored as well. For example (FIG. 10B), 1.43 can be built as close as possible to a square with a corner missing. Moving the top row to the right side, a rectangle is made up, and 1.43=1.3×1.1.

### Alternative Embodiments

A restriction on the number of digits, say, from √5 is due to the difficulty of subdividing a hundredth square chip into ten-thousandth square chips in the first embodiment. An alternative embodiment is to make the chips bigger for having ten-thousandth square chips which can be lumped in various ways. Games can be played on flat floor without any baseboard.

### Conclusion, Ramifications, and Scope

Accordingly, the reader will see that this craft of various embodiments can be used to perform virtually all the arithmetic operations: addition, subtraction, multiplication, division, square, square root, factoring, screening prime numbers, and finding LCM. Kids knowing how to count should be able to learn basic math by such a vivid method that let them see math of real things which can be played with fun. Square, the most fundamental shape of geometry, should be able to impress the kids with its beauty and power in those games. They should be able to learn more, and more quickly. The Magic Squares certainly support the idea of modeling in secondary or elementary math education.

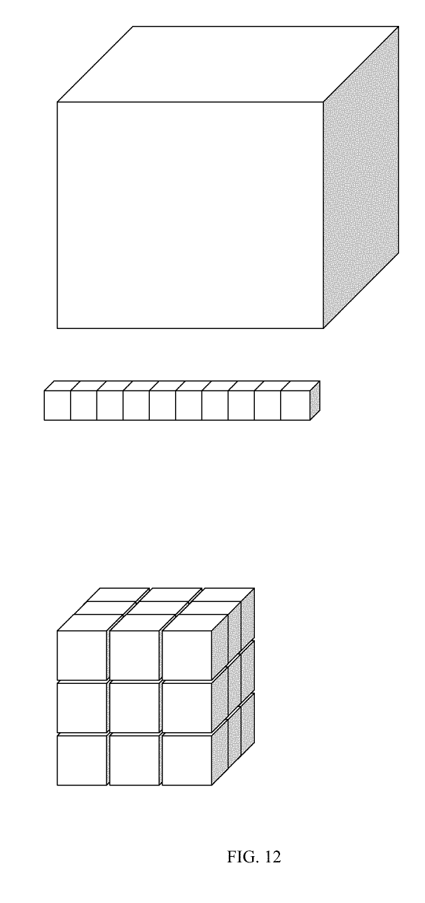

With foldable or aired cubes, the arithmetic games can be played in 3-dimension on flat floor. An assembly is shown in FIG. 12. In addition, rectangular prisms can be built for testing multiplicative associativity, and factoring a number into a product of three numbers, etc. More interestingly, cubes and cube roots can be carried out to digits after decimal point.

Although the description above contains several specificities, these should not be construed as limiting the scope of the embodiments but as merely providing illustrations of some of the embodiments. The scope of the embodiments should be determined by the appended claims and their legal equivalents, rather than by the examples given.

I claim:

1. The method of representing the unit of natural numbers by a unit square based on the concept of area for the purpose of performing a system of arithmetic operations: addition, subtraction, multiplication, division, square, square root, screening prime numbers, factoring, and finding LCM.

2. Dividing a unit square into 100 hundredth squares for the operations of addition, subtraction, multiplication, division, square, square root, and factoring on numbers with decimal point.

3. Representing large numbers such as 1000, 10000, etc., by unit square for operations on large numbers.

4. Building rectangles (or squares) for multiplication, division, square, and factoring, and finding the results from the chip marks.

5. The method of finding the digits of an irrational number resulted from square root by rebuilding a square.

6. The rectangle screen of prime numbers: no rectangle can be built by a prime number (excluding unit-side ones by definition).

7. Showing symmetry of the width and length of a rectangle so that screening a prime number begins with a square and goes on in one direction.

8. Testing on one side by prime numbers only in building rectangles for screening.

9. Lumped square chips and a square baseboard.

10. Finding cubes and cube roots by building or rebuilding a cube.
